(19) United States
(12) Patent Application Publication
(10) Pub. No.: US 2012/0204976 A1
(43) Pub. Date: Aug. 16, 2012

(54) Compressed Gas Regulator Apparatus

(75) Inventors: Shmuel Dovid Newman, Redondo Beach, CA (US); Jeff Brown, North Logan, UT (US)

(73) Assignee: YSN Imports, Inc., Gardena, CA (US)

(21) Appl. No.: 13/451,243

(22) Filed: Apr. 19, 2012

Related U.S. Application Data
(63) Continuation of application No. 12/687,031, filed on Jan. 13, 2010, now abandoned.
(60) Provisional application No. 61/144,835, filed on Jan. 15, 2009.
(60) Provisional application No. 61/215,766, filed on May 8, 2009.

(51) Int. Cl. G05D 16/04; F16K 31/12

(52) U.S. Cl. 137/505.42; 137/505

(57) ABSTRACT

Regulators for regulating gas that is delivered in discrete charges from a tank that contains compressed gas to a paintball gun, marker, or other application that utilizes or is activated by pressure controlled discrete charges of gas. The regulator has holding, discharge, and fill configurations, controlled by the movement of a piston member in a pressurized chamber, and the activation of a poppet valve on the discharge of the system. One or two low side pressure relief members are provided to prevent the over-pressurization of the pressurized chamber. An externally threaded sleeve member is non-rotatably, but axially slidably received on a distal portion of the body of the regulator so that the sleeve member and distal portion may be axially slidably disengaged, and the regulator can be rotationally positioned so that the pressure gauge is easily viewed by an operator.

### RELATED APPLICATIONS

This application is a continuation of U.S. application Ser. No. 12/687,031, filed Jan. 13, 2010, which claims the benefit of U.S. Provisional Application No. 61/144,835 filed Jan. 15, 2009 and U.S. Provisional Application No. 61/215,766 filed May 8, 2009, the content of each of which is incorporated by this reference in its entirety for all purposes as if fully set forth herein.

### TECHNICAL FIELD OF THE INVENTION

The present invention relates generally to regulators for regulating gas that is delivered in discrete charges from a tank that contains compressed gas to a paintball gun, marker, or other application that utilizes or is activated by pressure controlled discrete charges of gas.

### BACKGROUND OF THE INVENTION

Regulators that deliver discrete charges of pressure controlled gas are employed in a wide variety of industries where discrete charges of pressurized gas are used to, for example, activate controls, provide control, propel projectiles, provide feedstock, diluent, catalyst, carrier, or fuel to processes, or the like. These industries share in common a need for a regulator that reliably and safely delivers accurately metered charges of gas at a controlled pressure and at scheduled times or on demand. One such industry that requires such discrete charges is the paintball game industry.

The popularity of paintball games has grown immensely, and with that growth there has been a proliferation of different types of paintball guns (sometimes described as markers), and the devices that are used in conjunction with these markers, such as adapters, regulators and compressed gas tanks. Improvements in markers and related devices have become necessary due to the increased level of play as players improve and hone their skills. Improvements in paintball equipment encourage improvements in the players' abilities and skills, which in turn requires further improvements in the equipment. The early types of markers and related devices provided an adequate level of play. However, the onset of more experienced players, along with challenging paintball gun tournaments, now provides an arena where better markers and peripherals are required to sufficiently compete.

As used herein “tank” includes all manner of pressure vessels, including, but not limited to small portable bottles or tanks, large stationary tanks, tanks connected to compressors, metallic containers, composite plastic containers, single or plural use pressure vessels, or other supplies of compressed gas, whether connected directly or indirectly to a pressure regulator, and the like.

Safety is a serious concern with any system where pressurized gas is confined or handled in the equipment. Tanks typically confine gas under several thousand pounds of pressure (psi). Regulators that are in gas receiving communication with such canisters are sometimes exposed to the pressure that is in the tank. Regulators generally function to regulate the pressure that associated applications are exposed to. Often such associated applications are not capable of withstanding the gas pressure that is in the tanks. Unexpected spikes in gas pressure are sometimes encountered by such tanks and associated adapters and regulators. Regulators must be designed to reliably prevent excessive gas pressure from reaching the associated applications. Regulators are typically designed with sufficient strength to confine and regulate pressurized gas with a safety factor of at least twice the maximum anticipated pressure. This safety requirement dictates that the regulator be constructed with sufficient mass to provide the required strength. This makes the regulator heavier and larger than desired in many systems. Improvements are needed in this area, but without compromising safety.

In general, in paintball games a marker is used to fire or shoot a paintball at an intended target. A discrete charge of compressed gas is delivered through a regulator to a paintball marker to propel a paintball towards the intended target. The flow of gas from the tank to the marker is not continuous. The marker or paintball gun is typically attached directly or indirectly through a suitable conduit and adapter to a regulator, which is in turn attached to a source of compressed gas, such as a tank. The regulator meters the volume and controls the pressure of a charge of gas that is delivered to the marker. Typically, during the initial phases of operation the pressure in the tank is several times the output pressure from the regulator. For example, the pressure in the tank may be as much as 3,000 to 4,500 pounds per square inch (psi) or more, and the designed output pressure from the regulator in paintball systems may be approximately 800 psi, more or less. For other systems the output pressure may range from as little as approximately 5 or 10 psi to as much as approximately 1,000 psi or more. The regulator delivers gas to the marker at a predetermined maximum pressure one discrete charge at a time. The regulator accepts pressurized gas from a tank until the pressure within the regulator reaches a predetermined value and then shuts off the flow of gas into the regulator.

In paintball games the charge of gas is held in the regulator for an indefinite period of time until the player fires the marker. That is, the charge is available instantaneously for on demand use. For some applications charges are released at previously scheduled regular or irregular intervals. Releasing the charge immediately exhausts the charge from the regulator and delivers it to the marker or other application. The regulator then seals itself from outputting gas to the marker and opens its inlet to receive another charge of gas from the tank, and the cycle of fill, hold, and discharge starts over.

Cycle rates (the maximum number of complete fill-hold-discharge cycles per second) should generally be in the order of at least approximately 2 to 10 cycles per second. Reliable cycle rates in excess of this may be required or desired for other applications.

The overall marker-regulator-tank and any associated adaptor system in a paintball gun application is awkward and heavy to handle and carry when the components are large and heavy. Even a small reduction in size and/or weight is significant in increasing the usability and enjoyment of using the system. It is important for a user of a system to know the pressure in the tank as usage proceeds. By knowing the pressure level in a tank, an operator is able to determine approximately how many more discrete charges of gas are available before the tank will need to be recharged. To be of maximum usefulness a pressure gauge must be positioned to permit easy viewing at a glance. Where a regulator is threadably mounted to an appliance, including adaptors and other devices, fully tightening the threaded connection may cause the regulator to rotate so that the pressure gauge is out of the operator's view. The high pressure side in a regulator is typically exposed to the pressure in the tank. The low pressure side in a regulator is typically exposed to only the level of pressure that exists in the pressurized chamber within the regulator. Pressure relief valves or rupture disks are typically employed on the high pressure side. For safety reasons it is necessary to employ at least one and sometimes two pressure relief members on the low pressure side. There is a need for improvements.

Many paintball guns operate on compressed gas such as air or nitrogen or other gasses or mixtures of gasses. The players typically carry a supply of compressed gas with them as they compete. This supply is depleted after a certain number of cycles. Typically, the players have no means of replenishing this supply of compressed gas without returning to some central station removed from the playing field. Compact lightweight systems that extend the number of cycles that are available from one canister full of gas are much sought after by players, as are reliable and easy to read indicators of the likely remaining number of cycles.

Certain embodiments of systems operate by drawing charges of compressed gas from a closed tank. An inherent characteristic of such systems is that the pressure in the closed tank drops with each discharge. Even if a compressor is attached to a tank, the pressure in the canister fluctuates between compression cycles as the compressor starts and stops. An operator generally needs ready access to information about the pressure in the tank for safety and other operating considerations. The same concerns exist in any industries where discrete charges of gas are used. Where, for example, reactions, equipment or process controls are accomplished or activated by a predetermined charge of gas it is critical that the performance of the regulator be predictable. Knowing the pressure in the tank at any given moment is often critical to an operator's predicting what the performance will be for a given discharge of a discrete charge of gas. There is a clear and significant need for improvement in this area.

There are safety concerns with devices that operate on compressed gas. If the pressure in the tank exceeds the pressure rating for the tank, there must be an immediate relief of the pressure in the tank to avoid an explosion. Likewise, if the pressure within the regulator exceeds the pressure that the associated application or the regulator itself can safely accommodate, then there must be an immediate relief of the pressure in the regulator. The relief of the pressure in either the tank or the regulator must be reliable and should be accomplished in such a way that the operator is not exposed to any hazards. There is need for improvement in this area.

Examples of regulators for regulating pressurized gas that is delivered from a tank to a paintball gun or a marker are illustrated in Colby U.S. Pat. No. Des. 357,967, Colby U.S. Pat. No. 6,543,475, Colby U.S. Pat. No. 6,405,722, Carroll U.S. Pat. No. 6,851,447, Carroll U.S. Pat. No. 6,363,964, Gabrel U.S. Pat. No. 7,004,192, Gabrel U.S. Pat. No. 7,188,640, Gabrel U.S. Pat. No. 6,722,391, and Gabrel U.S. Pat. No. 6,478,046, each of which is hereby incorporated by reference as if fully set forth herein. Colby U.S. Pat. No. 6,405,722 discloses a piston type regulator wherein pressurized gas is injected through the body of the housing to recharge an attached pressure vessel. The pressurized gas flows past part of the regulator mechanism through the same channel that gas is discharged from the attached pressure vessel to the regulator. Gabrel U.S. Pat. No. 7,004,192, and these other Gabrel patents are similar in design to the Colby U.S. Pat. No. 6,405,722 piston type regulator except that Gabrel provides an on-off valve in the discharge channel that may be closed during filling of the attached pressure vessel to protect the regulating mechanism from the high pressure gas flow. A separate fill passageway runs into the pressure vessel through a side wall of the coupling that attaches to the pressure vessel. Co-pending U.S. patent application Ser. No. 12/115,481, filed May 5, 2008, which is a continuation-in-part of Ser. No. 12/022,996, filed, Jan. 30, 2008, (published as US 2008/0210210) both of which claim the benefit of provisional application Ser. No. 60/898,273, filed Jan. 30, 2007, relates to regulators of the general type described herein, and this co-pending application Ser. No. 12/115,481 is hereby incorporated herein by reference as though fully set forth hereat.

If a teaching of a reference or application herein incorporated by reference contradicts or is inconsistent with a teaching that is expressly set forth in the present application, the express teaching in the present application shall control.

Accordingly, there exists a need for a regulator for compressed gas that is safe, light-weight, compact, reliable, and that permits an operator to easily predict its performance characteristics each time it is activated. There is a need for the combination of these features in one regulator.

### SUMMARY OF THE INVENTION

In embodiments, a regulator is provided that provides improvements in safety, reliability, and functionality. Some embodiments provide improved functionality, particularly when the pressure within the canister is below the pressure at which the regulator is set to deliver gas charges to an attached device. Certain embodiments provide flexibility in accommodating or adapting various components for improved functionality and wider usage of common components. In some embodiments, improvements are achieved by reducing the number and complexity of the housing and operating components, which improves reliability and reduces cost. In some embodiments, fewer machining operations are required to manufacture the housing, thus reducing costs and improving quality.

In embodiments that are particularly suited for use, among other uses, in a marker-regulator-tank system, a distal end of a regulator is mounted to a device, such as an adaptor for a marker, through a fluid coupling that permits the regulator to be rotated generally about its longitudinal axis during assembly to present a pressure gauge so it may be viewed by an operator without substantially manipulating the system to bring the gauge into view. Also, for safety purposes at least one and in some embodiments, two low pressure side pressure relief members can be provided in such a marker-regulator-tank system.

According to current practice in the paintball industry, a regulator screws into an (ASA) or other adapter which, in turn, attaches to the marker. Other connections are contemplated, including, for example, quick disconnect couplings, hoses with appropriate connectors between supply of pressurized gas and the regulator, or between the regulator and the marker or other device, and the like. Any type of connection will suffice so long as it safely holds gas pressure and allows for activation of the system without interference with the operation of the system. In some embodiments, the regulator is connected by a hose to a marker or other device.

According to some embodiments, a canister provides an unregulated primary source of pressurized gas. A gas regulator is provided to regulate the delivery of gas charges to a marker or other device. In embodiments, the regulator may be preset to deliver discrete charges of gas to an attached application such as a marker at a particular volume, pressure, and cycle rate over a wide range of gas pressures in an attached tank.

In some embodiments, the regulator may be configured to address safety concerns. In some embodiments, the seal configurations are such that if for some reason the pressure within the regulator exceeds the pressure at which the attached device may safely receive a charge of gas, the gas will break through the seals in the regulator and vent from inside the regulator through a pressure relief channel to an ambient atmosphere until the pressure falls to a safe level. In some embodiments, if the tank is over pressurized, for example, during filing, a rupture disk is provided in the regulator to immediately vent the pressure in the tank to an ambient atmosphere.

Embodiments find utility in many systems in many different industries. Such systems where regulated charges of gas are utilized include, for example, propellant regulators for gas actuated guns, in military unclassified and classified use, in sea, land, and air vehicle servo systems, in medical procedural and exploratory manipulations, in fuel cells, and in industrial robotic and automated applications. Embodiments find utility in, for example, multi-step pressure reduction systems where embodiments provide one or more of the steps in reducing pressures from very high levels, for example, 8,000 to 10,000 psi, down to a desired operating level for a given system.

Certain embodiments are comprised of a regulator for regulating the delivery of pressurized gas from a supply of pressurized gas to a device that utilizes discrete charges of pressure regulated gas. Some embodiments include a regulator housing, that has proximal and distal ends, a specially configured bore including a pressure chamber therein, a proximal portion adjacent the proximal end, a distal portion adjacent the distal end, and a body portion extending between the proximal and distal portions. The proximal portion is adapted to being mounted in fluid flow communication with a pressure tank, and the distal portion is adapted to threadably engage an appliance that requires discrete charges of pressurized gas for its operation.

In certain embodiments a tank side seal member is mounted in the proximal portion. Typically, such mounting is rendered removable by the use of a threaded coupling. A tank side of the tank side seal member is exposed to high pressure gas that is in the pressure tank. A body side of the tank side seal member is exposed to low pressure gas in the pressure chamber. The tank side seal member includes a metering orifice extending therethrough from an inlet to an outlet. An input valve seat generally surrounds the outlet and generally faces towards the distal end.

In embodiments, a discharge side seal member is removeably mounted generally in the distal portion. The discharge side seal member has an outlet orifice extending therethrough between a first end and a second end. The second end opens to the distal end. An output valve seat generally surrounds the first end and generally faces toward the proximal end.

In embodiments, a poppet member is valvingly associated with the discharge seal member. The poppet member is generally mounted for movement in the outlet orifice between open and closed configurations. The poppet member is generally spring biased towards the closed configuration. The poppet member is adapted to sealingly engage the output valve seat in the closed configuration.

A piston member is mounted in the pressure chamber in sealing engagement with the piston receiving bore. The piston member is adapted to move between gas input, gas holding, and gas output configurations and to sealingly engage the input valve seat in the gas holding and gas output configurations. The piston member is resiliently biased by a spring member toward the gas input configuration. The piston member sealingly defines pressurized and un-pressurized chambers within the regulator. The un-pressurized chamber generally surrounds a portion of the piston member, and is open to an ambient atmospheric pressure. The pressure chamber extends within the regulator generally from the input valve seat to the output valve seat. A first surface portion of the piston member generally faces the proximal end and a second surface portion of the piston member generally faces the distal end. The first surface portion has a larger surface area than the second surface portion. Both the first and second surface portions are within the pressure chamber. The larger surface area is adapted to allowing a predetermined level of pressure within the pressure chamber to overcome the resilient bias of the spring member and move the piston member to sealingly engage the input valve seat in the gas holding and gas output configurations. The piston member moves against the resilient bias of the spring member responsive to the predetermined level of pressure in the pressure chamber. The pressure chamber is adapted to holding a discrete charge of pressurized gas at approximately the predetermined level of pressure until the poppet member is actuated to the gas output configuration by an operator.

According to certain embodiments, a sleeve member is axially slidably received on the distal portion of the body in a non-rotating relationship. The sleeve member is generally cylindrical and bears a male thread on its outer circumference. The male thread is adapted to threadably engaging a device in a system that requires discrete charges of pressurized gas for its operation. The sleeve member is releasably restrained from sliding axially of the distal portion. The non-rotating relationship is established, for example, by splines engaged in mating grooves, by studs engaged in mating sockets, by frictional engagement or by a single peripheral socket.

According to certain embodiments comprising spline-groove sets, the splines are on the sleeve member, and they are adapted to engage mating grooves in the distal portion. In certain embodiments comprising spline-groove sets, 3 splines and mating grooves are sufficient to allow the regulator and tank to be rotated during assembly to bring a pressure gauge for the tank into the operators view. From 2 to 4 mating spline-groove sets are sufficient for most uses, although 5 or 6 or more such spline-groove sets may be employed, if desired. Typically, the tanks are approximately symmetrical around their longitudinal axes, so the rotational orientation of the tank relative to the operator is of no substantial significance. The splines and mating grooves are arrayed generally symmetrically around the longitudinal axis of the distal portion of the body, so that each sleeve member can be installed with any spline received in any mating groove. Thus, the pressure gauge port may be positioned during assembly of the system so that a gauge inserted in the port is positioned at a convenient location for viewing by an operator of the system.

Similarly, according to certain embodiments comprising stud-socket sets, one or more studs are located on either a sleeve member or a shoulder portion of the body of the regulator. The studs are adapted to non-rotatably engage with mating sockets in the shoulder portion or the sleeve member. In certain embodiments comprising stud-socket sets, 3 studs and mating sockets are sufficient to allow the regulator and tank to be rotated during assembly to bring a pressure gauge for the tank into the operator's view. From 2 to 4 mating stud-socket sets are sufficient for most uses, although from 1 to 5 or 6 or more such stud-socket sets may be employed, if desired. Where no rotatable positioning of the components of the system relative to one another is desired, 1 such stud-socket set may be sufficient. In certain embodiments comprising stud-socket sets, the studs and mating sockets are arrayed generally symmetrically around the longitudinal axis of the shoulder portion of the body. Thus, each sleeve member can be installed so that any stud is received in any mating socket. Alternatively, certain other embodiments may include a greater number of mating sockets than studs, thereby allowing a sleeve comprising fewer studs to engage the selected mating sockets that allow elements of the system, for example, the pressure gauge port, to be positioned during assembly of the system as may be desired. Alternative embodiments may achieve this advantage by providing a single polygonal boss-socket engagement between the sleeve member and the regulator body.

In addition, according to certain embodiments enabling a frictional engagement between a sleeve member and the body of the regulator, the inner engagement surface of the sleeve member is adapted to non-rotatably engage the outer engagement surface of the distal portion of the body. As with other embodiments, this allows the regulator and tank to be rotated during assembly to bring a pressure gauge for the tank into the operator's view. However, an embodiment allowing frictional engagement offers the further advantage of enabling non-rotational engagement to occur in an infinite number of rotational positions.

Assembly of the sleeve to the proximal portion may be accomplished in several ways. The proximal portion, for example, may be rotated relative to the sleeve member before assembly. When the proximal portion is at the desired rotational position the sleeve member is axially slidably mounted to the proximal portion and the discharge side seal member is mounted in the distal portion to retain the sleeve member from sliding axially out of engagement with the distal portion. The rotational position of the regulator should be ascertained when the sleeve member is fully threadably tightened to the associated appliance. If desired, the position of the sleeve member may be marked and the sleeve member removed from the appliance to allow adjustment of the rotational position of the regulator body relative to the sleeve.

In embodiments, a discharge side seal member is removably mounted in the distal portion of the body. According to certain embodiments, the discharge side seal member is adapted to releasably restrain the sleeve member from sliding axially of the distal portion. Such restrain is accomplished, for example, by providing the discharge side seal member with a flange that is adapted to extend generally radially over a distal end of the sleeve member to releasably restrain the sleeve member from sliding axially of the distal portion of the body. The radial extent of the flange is such that it does not interfere with the threadable engagement of the sleeve with an associated appliance or other system element.

In certain embodiments, the body portion includes a fill port, a high pressure side gauge port, a high pressure side relief port, and a low pressure side relief port. The fill port, high pressure side gauge port, and high pressure side relief port are adapted to being exposed to the level of pressure that is exerted by the high pressure gas in the tank. The low pressure side relief port is adapted to being exposed to the level of pressure that is exerted by the gas in the pressure chamber.

Typically, the high pressure side relief port is exposed to the level of pressure that exists within the tank. This relief port is adapted to protect the tank from over-pressurization with the attendant risk of bursting of the tank. Tanks have a maximum rated pressure above which they become unsafe. Typically, the predetermined amount of pressure under which the high pressure side relief port opens is several hundred pounds per square inch less than the maximum rated safe pressure level for the tank.

Typically, the low side pressure relief port is exposed to the level of pressure that exists within the pressure chamber in the body of the regulator. The purpose of the low pressure relief port is to prevent over-pressurization of the pressure chamber with its attendant risk of exploding the regulator and/or the apparatus that is attached to the regulator. The low pressure side relief port is adapted to opening to relieve pressure in the pressure chamber responsive to a level of pressure in the pressure chamber that exceeds a predetermined amount of pressure. The predetermined amount of pressure in the pressure chamber is typically several hundred pounds per square inch below the maximum safe pressure level for the pressure chamber and associated apparatus. In certain embodiments an extra measure of safety is provided by enabling a second low pressure side relief member in the form, for example, of seals for the pressure chamber that release to allow gas to vent from the pressure chamber at approximately the same pressure that activates the opening of the low pressure side relief port.

Some embodiments include a fill port in the body portion, and a fill channel extending in the regulator housing from the proximal end into the fill port without intersecting the specially configured bore.

The tank side seal member is comprised of a metering orifice and an input valve seat positioned to be engaged by a resilient seal carried on the proximal end facing end of the piston member. The spring member resiliently biases the piston member out of engagement with the input valve seat into an input configuration. This is the default un-pressured configuration. When the pressure on the larger distally facing surfaces of the piston member reaches the pressure at which the regulator is set, this pressure overcomes the combined spring bias and gas pressure on the relatively smaller proximally facing surfaces of the piston member. The piston member then slides axially of the specially configured bore into sealing engagement with the input valve seat. This is the holding configuration, which exists until the pressure is released from the pressurized chamber by moving the poppet member to an open configuration. The poppet member is moved to the open configuration by some element that is generally external to the regulator. Typically, this external element is a poppet actuator that forces the poppet member into the regulator housing far enough to release the poppet member from sealing engagement with the output valve seat on the output valve seat member. Generally, the poppet member is resiliently biased by a poppet spring toward engagement with the output seat member, and the poppet actuator releases the poppet member as soon as the charge is emitted from the regulator. This release is generally substantially instantaneous so that the release and resealing of the poppet member is substantially simultaneous with the release of the seal element on the proximally facing end of the piston member from the input valve seal. Refilling of the pressurized chamber with pressurized gas thus generally occurs within a fraction of a second after a charge is expelled from the regulator. Once the pressure builds up in the pressurized chamber it forces the piston member from the open configuration to the holding configuration, and the cycle is complete.

The tension in the spring member that biases the piston member generally determines the operating pressure (output pressure) of the regulator. In general, the greater the spring tension, the higher the operating pressure, because it takes more pressure to overcome the spring tension as the spring tension increases. The spring tension may be selected to produce a charge pressure of from approximately 10 psi to 1,000 or more psi, depending on the requirements of a particular associated device.

The piston member requires enough surface area on the distally facing surfaces so the gas pressure on those surfaces will overcome the opposing forces (spring tension and gas pressure on the relatively smaller proximal end of the piston member) when the desired pressure within the regulator has been achieved. This requires that the piston be larger on the distally facing end than it is on the proximally facing end. Typically, a portion of the distally facing piston surface is exposed to ambient atmospheric pressure.

For reasons of availability, convenience and expense, air is typically the preferred gas, but other gasses such as carbon dioxide, nitrogen, mixtures of various gasses, and the like may be used, if desired. Where the gas is a feedstock, carrier, or catalyst for a process, the gas that is necessary for the desired reaction is used.

Embodiments of the regulator may be constructed of various materials, including aluminum alloys, engineering plastics, stainless steel, or the like. The materials will be selected by those skilled in the art of regulators depending on such factors as the intended operating environment (corrosive, abrasive, impact, or the like), anticipated operating pressures and temperatures, and the like, as a specific application may dictate.

In some embodiments of the regulator wherein excess pressure within the pressure chamber is relieved by blowing past the seals of the pressure chamber to atmospheric pressure, the provision of a low pressure side relief port provides a further measure of safety.

The detailed description of embodiments of the regulator is intended to serve merely as examples, and is in no way intended to limit the scope of the appended claims to these described embodiments. Accordingly, modifications to the embodiments described are possible, and it should be clearly understood that the invention may be practiced in many different ways than the embodiments specifically described below, and still remain within the scope of the claims.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic side view depicting an embodiment of a regulator body;

FIG. 2 is a diagrammatic end view of a proximal end of an embodiment of FIG. 1;

FIG. 3 is a diagrammatic cross-sectional view taken along Line 3-3 in FIG. 1;

FIG. 4 is a diagrammatic cross-sectional view taken along line 4-4 in FIG. 3;

FIG. 5 is a diagrammatic cross-sectional view taken along Line 5-5 in FIG. 1;

FIG. 6 is an additional diagrammatic side view depicting an embodiment of FIG. 1;

FIG. 7 is a diagrammatic cross-sectional view of an embodiment of a regulator from which the piston member and poppet member biasing springs have been removed for purposes of clarity of illustration;

FIG. 8 diagrammatically depicts a distal end view of a discharge side seal member;

FIG. 9 diagrammatically depicts a cross-sectional view taken along line 9-9 in FIG. 8;

FIG. 10 diagrammatically depicts a side view of the embodiment of FIG. 8;

FIG. 11 diagrammatically depicts an end view of a low side pressure relief member;

FIG. 12 diagrammatically depicts a side view of the embodiment of FIG. 11;

FIG. 13 diagrammatically depicts a cross-sectional view taken along line 13-13 in FIG. 11;

FIG. 14 diagrammatically depicts an exploded broken view including the distal portion of the embodiment of FIG. 7;

FIG. 15 is a diagrammatic isometric view of an embodiment of a sleeve member that includes rotation preventing studs;

FIG. 16 is a further diagrammatic isometric view of the embodiment of FIG. 15;

FIG. 17 diagrammatically depicts an end view of the embodiment of FIG. 15;

FIG. 18 diagramatically depicts a cross-sectional view taken along line 18-18 in FIG. 17;

FIG. 19 is a diagrammatic isometric view depicting a further embodiment of a regulator body that includes sockets that are adapted to receive mating studs in a socketed relationship to render a sleeve member non-rotatable relative to the regulator body;

FIG. 20 is a diagrammatic cross-sectional view of a further embodiment of a regulator from which the piston member and poppet member biasing springs have been eliminated for purposes of clarity of illustration;

FIG. 21 diagrammatically depicts an exploded broken view including the distal portion, shoulder portion, and associated sleeve member and discharge side seal member of the embodiment of FIG. 20;

FIG. 22 is a diagrammatic isometric view of an embodiment of a sleeve member that includes rotation preventing sockets adapted to non-rotatably engage with mating studs on, for example, a body (not shown);

FIG. 23 diagrammatically depicts an end view of the embodiment of FIG. 22;

FIG. 24 diagramatically depicts a cross-sectional view taken along line 24-24 in FIG. 23;

FIG. 25 diagrammatically depicts an end view of a further embodiment of a sleeve member that includes rotation preventing generally rectangular studs adapted to non-rotatably engage with mating sockets on, for example, a body (not shown);

FIG. 26 diagrammatically depicts an end view of a further embodiment of a sleeve member that includes two rotation preventing generally arcuate studs adapted to non-rotatably engage with mating sockets on, for example, a body (not shown); and

FIG. 27 diagrammatically depicts an end view of a further embodiment of a sleeve member that includes a single rotation preventing generally arcuate stud adapted to non-rotatably engage with mating sockets on, for example, a body (not shown).

FIG. 28 is a diagrammatic cross-sectional view of a further embodiment of a regulator similar to FIG. 20, but where a sleeve member with a tapered internal engagement surface is frictionally non-rotatably engaged to a distal end of a body;

FIG. 29 diagrammatically depicts an exploded broken view including the distal portion, shoulder portion, and associated sleeve member and discharge side seal member of the embodiment of FIG. 28;

FIG. 30 is a diagrammatic isometric view of an embodiment of a sleeve member that includes an annular boss having a polygonal periphery adapted to non-rotatably engage with a polygonal socket in, for example, a shoulder of a body (not shown);

FIG. 31 diagrammatically depicts an end view of the embodiment of FIG. 30;

FIG. 32 diagramatically depicts a cross-sectional view taken along line 32-32 in FIG. 31;

FIG. 33 is a diagrammatic isometric view depicting a further embodiment of a regulator body that includes a polygonal socket adapted to receive an annular boss having a polygonal periphery to render a sleeve member non-rotatable relative to the regulator body;

FIG. 34 is a diagrammatic isometric view of an embodiment of a sleeve member that includes a polygonal socket adapted to non-rotatably engage with a polygonal periphery portion of, for example, a shoulder of a body (not shown);

FIG. 35 diagrammatically depicts an end view of the embodiment of FIG. 34;

FIG. 36 diagramatically depicts a cross-sectional view taken along line 36-36 in FIG. 35;

FIG. 37 is a diagrammatic isometric view depicting a further embodiment of a regulator body that includes a polygonal periphery portion adapted engage a polygonal socket to render a sleeve member non-rotatable relative to the regulator body;

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications.

### DETAILED DESCRIPTION OF THE INVENTION

The following description of preferred embodiments generally relates to regulators for regulating the delivery of discrete charges of gas at predetermined pressures in systems that utilize such pressure regulated gas charges. Certain embodiments of the present invention comprise regulators for compressed gas that exhibit rotational adjustability during assembly. In some embodiments, for added safety, one or two pressure relief members are provided on the low pressure side of the regulator. Certain embodiments of the regulator are adapted to being attached to a marker or paintball gun (not shown) to regulate the flow of compressed gas to the marker. The same or similar elements that appear in different Figs. have been assigned the same reference numbers for purpose of ease of understanding.

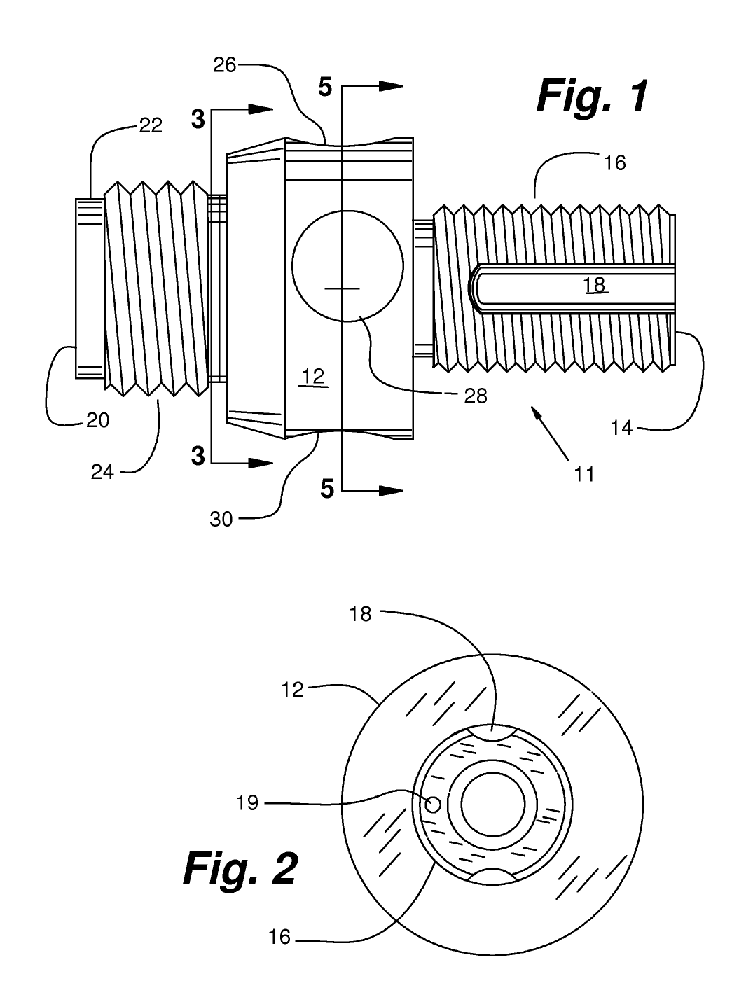

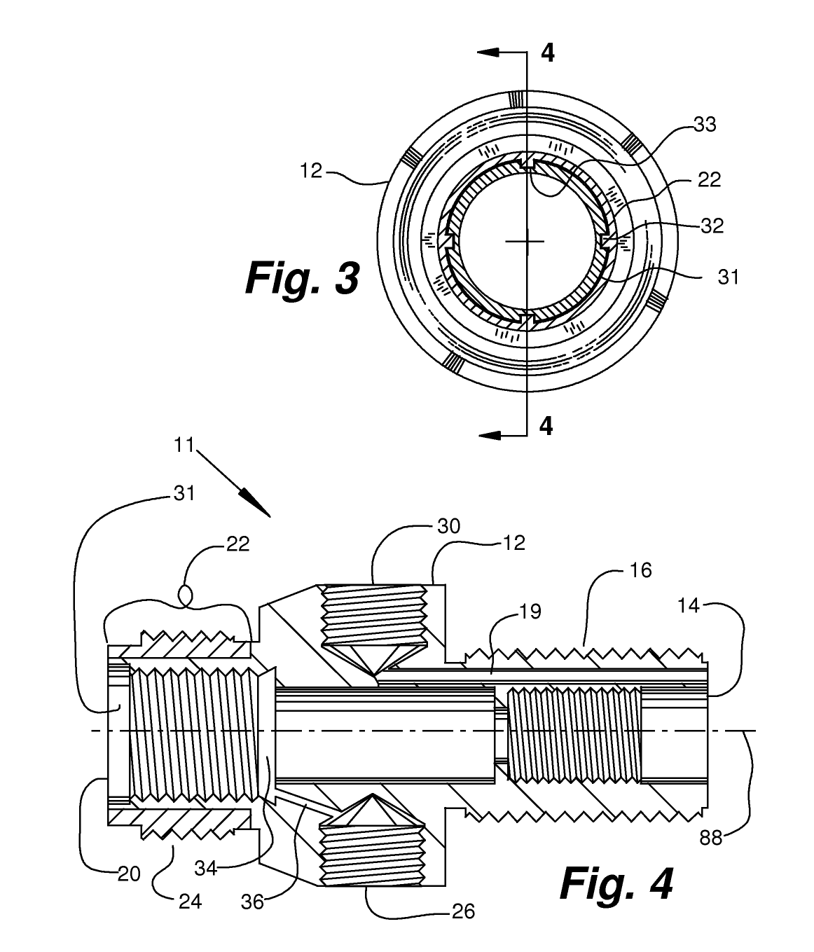

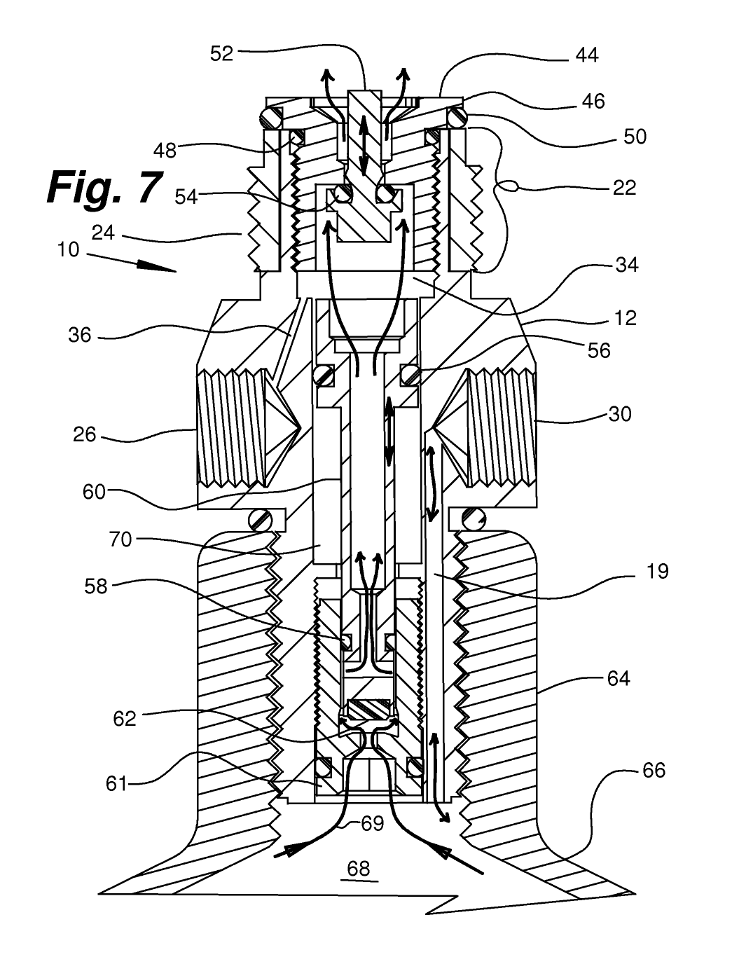

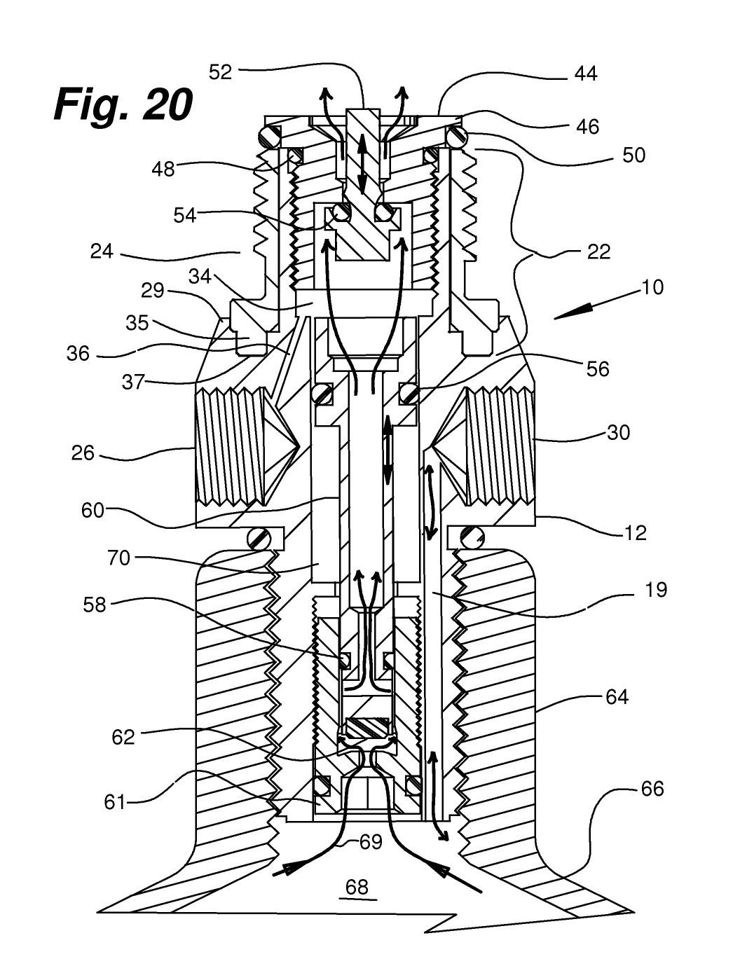

Referring particularly to the Figs. in the accompanying drawings for the purposes of illustration of the best mode only, and not limitation, there is illustrated generally at 10 (see, for example, FIGS. 7 and 20) a regulator that includes a regulator body indicated generally at 11 (see, for example, FIGS. 1 and 4). Regulator body 11 extends from proximal end 14 to distal end 20. Male thread 16 is located on a proximal portion of regulator body 11 that is adjacent proximal end 14. Bleed channel 18 extends generally axially through male thread 16 part way along the distal portion. If Regulator 10 is partly unthreaded from a threadably associated tank, bleed channel 18 will allow pressurized gas 68 to vent from the tank before the proximal portion of regulator body 10 can be entirely unthreaded from the tank. This venting prevents the regulator 10 from being forcefully ejected from the tank when the regulator is unscrewed from a tank that contains gas under pressure. Distal portion 31 (for example, FIGS. 3, 14, and 21) is adjacent distal end 20.

In the embodiments chosen for illustration, male thread 16 is adapted to be threadably mounted in tank neck 64 (see, for example, FIGS. 7 and 20). Tank wall 66 serves to confine therewithin a body of pressurized gas 68. The flow of gas through regulator 10 from proximal end 14 to distal end 20 is illustrated at, for example, typical line 69, and the continuations of typical line 69 to its discharge at distal end 20. The tank side of tank side seal member 61 is exposed to the pressurized body of pressurized gas 68.

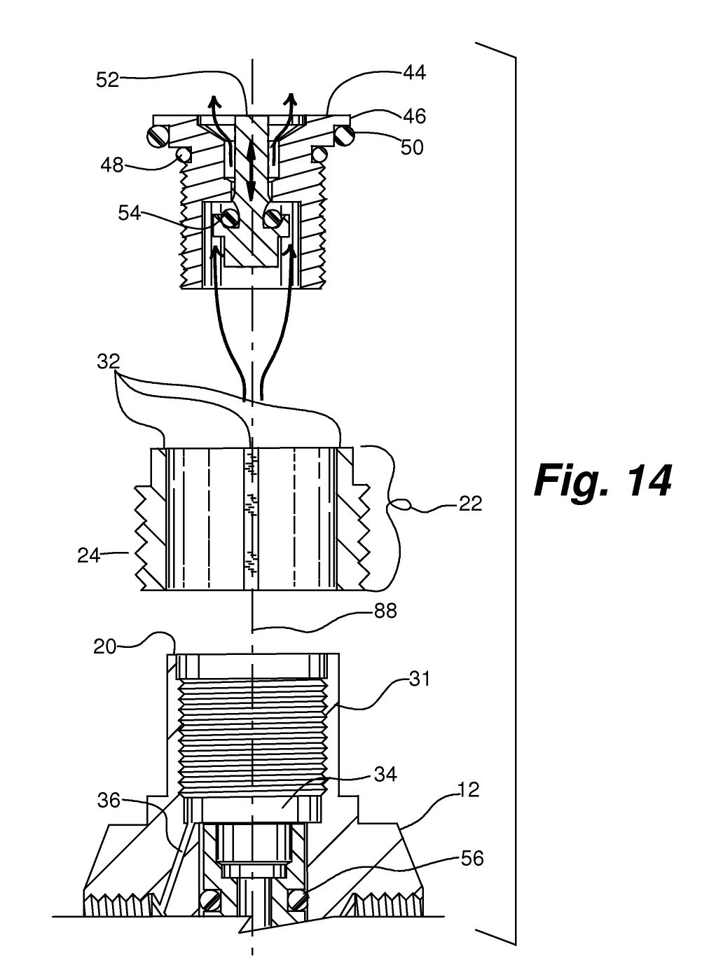

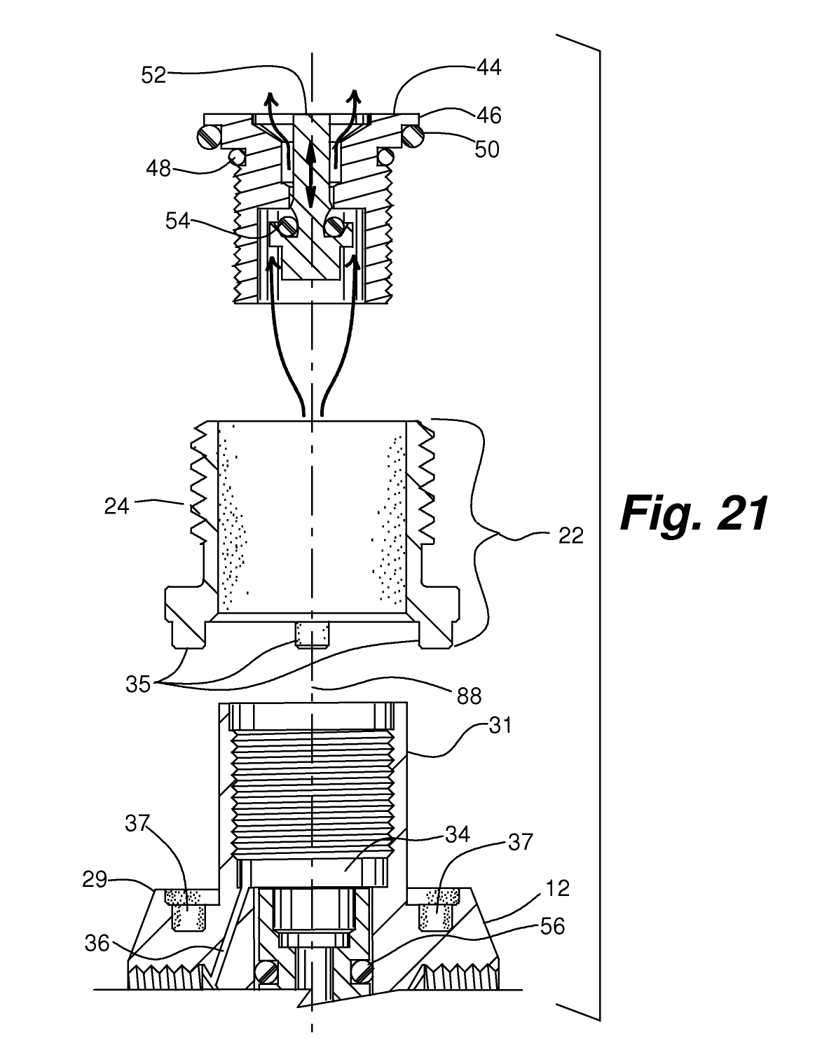

When the seal in tank side seal member 61 is open in a fill configuration, pressurized gas from the tank flows into the input side of regulator 10 through a metering orifice and then into pressure chamber 34 in regulator body 11. When both the valves on the input and discharge sides of regulator 10 are closed, the regulator is in a pressurized charge holding configuration of indefinite duration. A single discrete charge of gas under a predetermined level of pressure is held in the pressure chamber 34 until the poppet member 52 is depressed to open the poppet valve on the discharge side of regulator 10. Pressure chamber 34 begins, for example, at about the metering orifice in tank side seal member 61, and extends through several sub-chambers to about where poppet seal 54 sealingly engages discharge side seal member 44 (see, for example, FIGS. 7, 8-10, 14, 20 and 21). When the poppet member 52 is depressed it opens the poppet valve by moving poppet seal 54 away from sealing engagement with the output valve face in discharge side seal member 44. This places regulator 10 is in a discharge configuration. In FIGS. 14 and 21 the poppet valve in discharge side seal member 44 is illustrated in an open configuration. In FIGS. 7 and 20 the poppet valve in the discharge side seal member is shown closed, and the input valve in the tank side seal member is shown in an open configuration. A spring (not shown), generally in the form of a compression coil spring, is positioned in pressure chamber 34. This coil spring extends between poppet member 52 and piston member 60, and serves to urge the poppet valve towards the closed configuration.

In the embodiments chosen for illustration, piston member 60 is resiliently biased toward the open configuration shown, for example, in FIGS. 7 and 20, by a spring member (not shown). In certain embodiments the spring member takes the form of a compression coil spring (not shown) that resides in spring chamber 70 and surrounds the strut of piston member 60. Spring chamber 70 is open to the ambient atmosphere so that the distal facing shoulder of piston member 60 against which the compression spring rests is not exposed to the much higher pressure in pressure chamber 34. The higher pressure on the distal facing piston member surfaces tends to move piston member 60 against the ambient pressure in spring chamber 70. The coil spring extends between a fixed annular ledge shown near the proximal end of spring chamber 70 through substantially the entire axial length of spring chamber 70 to bear compressively against an annular boss near the distal head of piston member 60.

In the embodiments chosen for illustration, pressure chamber 34 is sealed between first piston seal 58, which is located near the proximal end of piston member 60, and second piston seal 56, which is located near the distal end of piston member 60. Spring chamber 70 is similarly defined between seals 58 and 56. Spring chamber 70 is open to the atmosphere, and is thus exposed to whatever the ambient atmospheric pressure is. The proximal facing surface area of piston member 60 in pressure chamber 34 (mostly below first piston seal 58) is less than the distal facing surface area of piston member 60 in pressure chamber 34.

When the force exerted by the pressurized gas in pressure chamber 34 on the distal facing surfaces of piston member 60 within pressure chamber 34 exceeds the combined force of the biasing spring member, the ambient pressure in spring chamber 70, and the force exerted by the pressurized gas in pressure chamber 34 on the proximally facing surfaces of piston member 60, the piston member 60 moves to bring resilient seal member 62 into sealing engagement with the valve seal face in tank side seal member 61. This changes the configuration of the regulator from the fill configuration to the hold configuration. It will stay in the hold configuration with a discrete charge of pressurized gas confined in pressure chamber 34 until poppet member 52 is depressed by some force exterior to regulator 10 to release the discrete charge of pressurized gas from pressure chamber 34. With some applications the holding time is indefinite, so discrete pressurized charge may be held in pressure chamber 34 for a fraction of a second or for several hours or more, as may be desired.

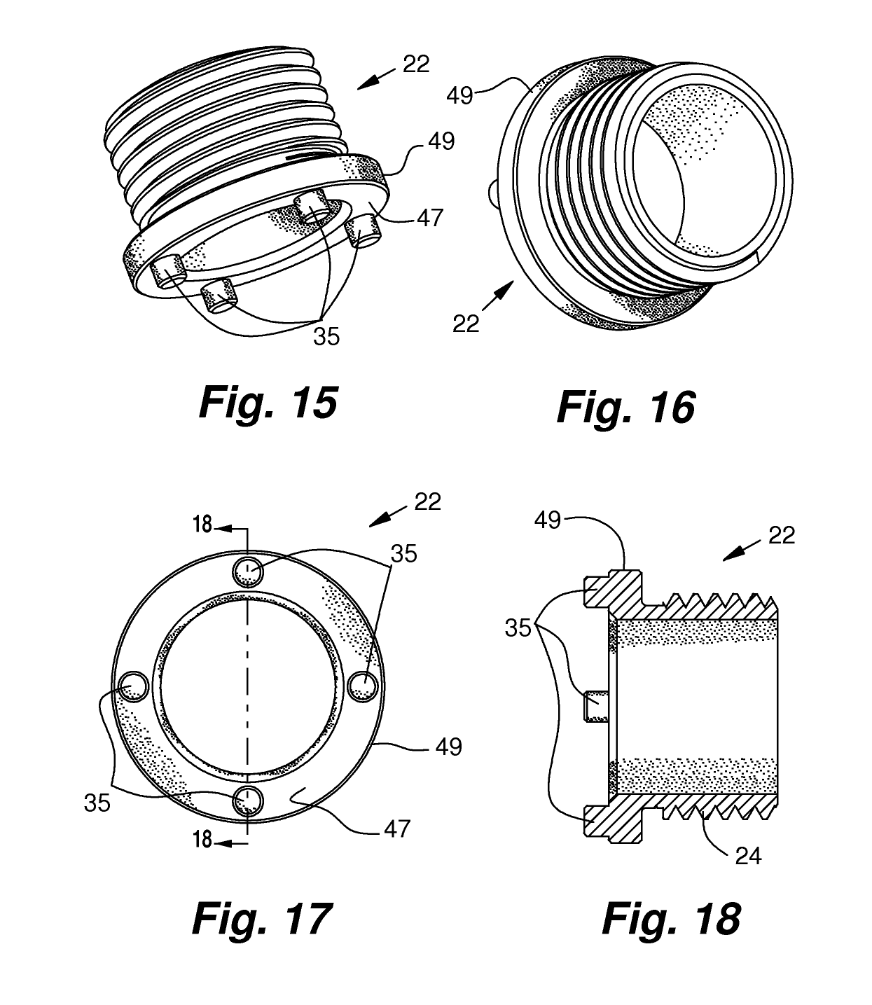

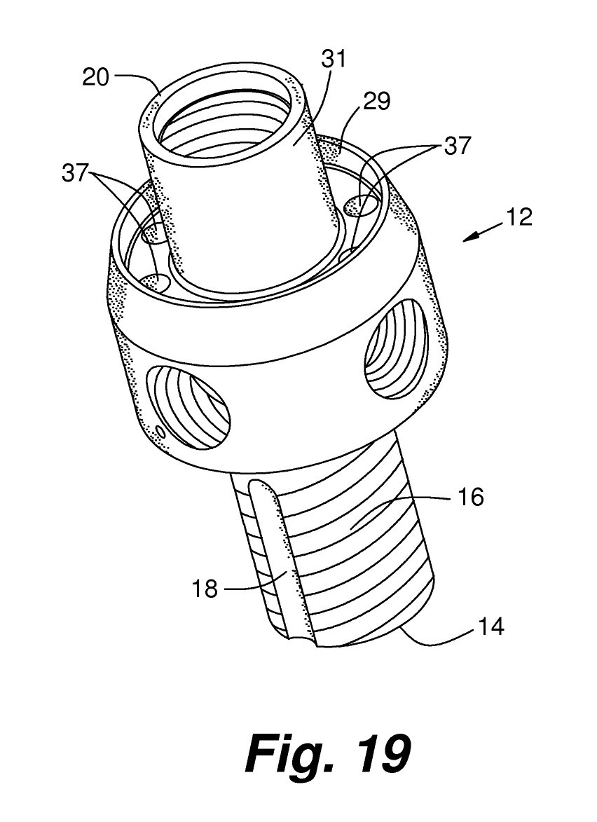

Sleeve member 22 is axially slidably received on distal portion 31. In the embodiments chosen for illustration, sleeve member 22 is slidable generally parallel to longitudinal axis 88 (see, for example, FIGS. 4, 14 and 21) onto distal portion 31. In the assembled configuration, sleeve member 22 is prevented from rotating relative to distal portion 31 by, for example, two or more splines engaged in mating relationship to mating grooves. Spline 32 is typical, as is mating groove 33 (see, for example, FIGS. 3 and 14). In an alternative embodiment chosen for purposes of illustration (see, for example, FIG. 20) sleeve member 22 is prevented from rotating relative to distal portion 31 by two or more studs 35 engaged in mating relationship to mating sockets 37. With regard to this alternative embodiment, FIGS. 15-18 illustrate a typical arrangement of studs 35 on the sleeve member 22, and FIG. 19 depicts an example of an array of mating sockets 37 symmetrically distributed around shoulder portion 29 of body portion 12. Referring in particular to FIG. 19, shoulder portion 29 is adjacent to distal portion 31 and spaced axially from distal end 20 for an axial distance sufficient to allow a sleeve member to be received on distal portion 31 in a non-rotatable operative configuration. In embodiments where there is non-rotatable interengagement between a sleeve member and a shoulder portion that prevents relative rotation between these, the axial distance is sufficient to allow such interengagement to exist,

Returning now, for example, to FIGS. 3, 14 and 21, A male thread 24 is provided on the exterior generally cylindrical surface of sleeve member 22. Male thread 24 permits threadable engagement with an appliance such as, for example, an adapter or marker. The regulator 10 rotates generally around its longitudinal axis 88 as male thread 24 is threadably mounted to an associated appliance, and it is uncertain due to machining differences, tolerances, and wear just where regulator body 11 will be rotational oriented when the thread is fully tightened to a mating thread in an appliance. If regulator body 11 is not rotationally oriented in a desired position when the thread is fully tightened, the sleeve member 22 may be slipped axially from engagement with the distal portion 31, and the regulator body 11 rotated until it is in the desired position. In many embodiments, three or four symmetrically arrayed mating spline-groove or stud-socket sets are sufficient to permit the desired rotational orientation to be effected. According to certain embodiments, at least two such mating spline-groove sets are required for rotational adjustment and as many as five, six, seven, or more symmetrically arrayed sets may be provided if fine rotational adjustment is desired for a particular application. There may, for example, be more sockets than studs in some embodiments, and more grooves than splines in certain embodiments. As illustrated in FIGS. 15-21, a similar arrangement can be applied to alternative embodiments that rely on mating stud-socket sets as a substitute for or in addition to mating spline-groove sets. Both stud-socket sets and spline-groove sets may be employed in an embodiment, if desired. In stud-socket embodiments, three or four mating stud-socket sets are sufficient to permit the desired rotational orientation to be effected. At least two such mating sets are generally required and as many as five, six, seven, or more symmetrically arrayed sets may be provided if fine rotational adjustment is desired for a particular application. There may be more sockets than studs. For example, there may be one stud and two or more sockets to permit rotational adjustment of a sleeve member relative to a distal portion. Further, embodiments with stud-socket sets can take on a variety of cross sectional shapes.

In the embodiment depicted, for example, in FIGS. 3, 4, 7 and 14, the splines and mating grooves are arrayed generally symmetrically around longitudinal axis 88 so that any spline will mate with any mating groove, and there may be more grooves than splines. There may be, for example, one spline and several grooves. The splines, for example, are shown on the sleeve member 22, and the mating grooves 33 are in distal portion 31. As will be understood by those skilled in the art, the mating grooves may be in the internal generally cylindrical surface of sleeve member 22, and the splines may be on the mating generally external cylindrical surface of distal portion 31. According to certain embodiments, the cross-sectional shape of the splines and mating grooves is generally not critical, and may be arcuate, rectangular, dove-tail, V-shaped, combinations thereof, or the like, as may be desired.

The mating spline-groove sets need not extend the full length of the sleeve member 22 or the distal portion 31. For example, in certain embodiments (not illustrated), splines 32 may extend axially only part way along the inner cylindrical surface of sleeve member 22 from distal end 14, while the mating grooves 33 extend axially in a similar manner only part way along distal portion 31 from distal end 14. Such truncated mating spline-groove sets may extend in some embodiments for from approximately two-thirds to one-third the axial lengths of the sleeve member and distal portion 31. This permits sleeve member 22 to be moved axially of distal portion 31 and then rotated relative to distal portion 31 without removing sleeve member 22 entirely from distal portion 31. This facilitates making a desired rotational adjustment between sleeve member 22 and regulator body 11.

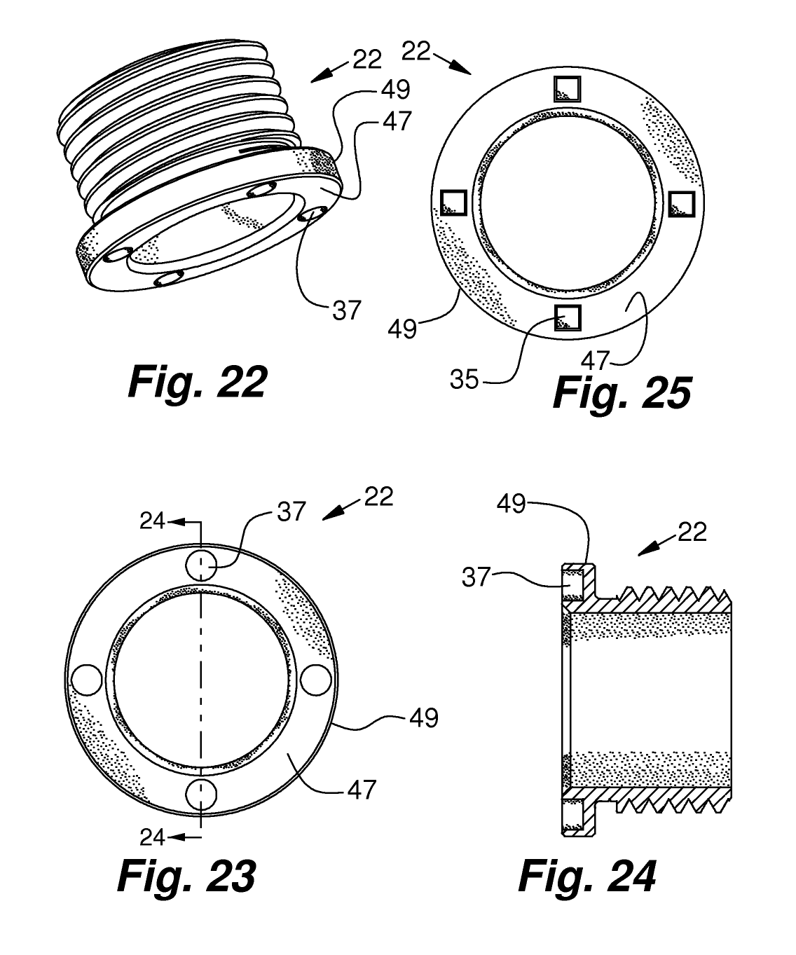

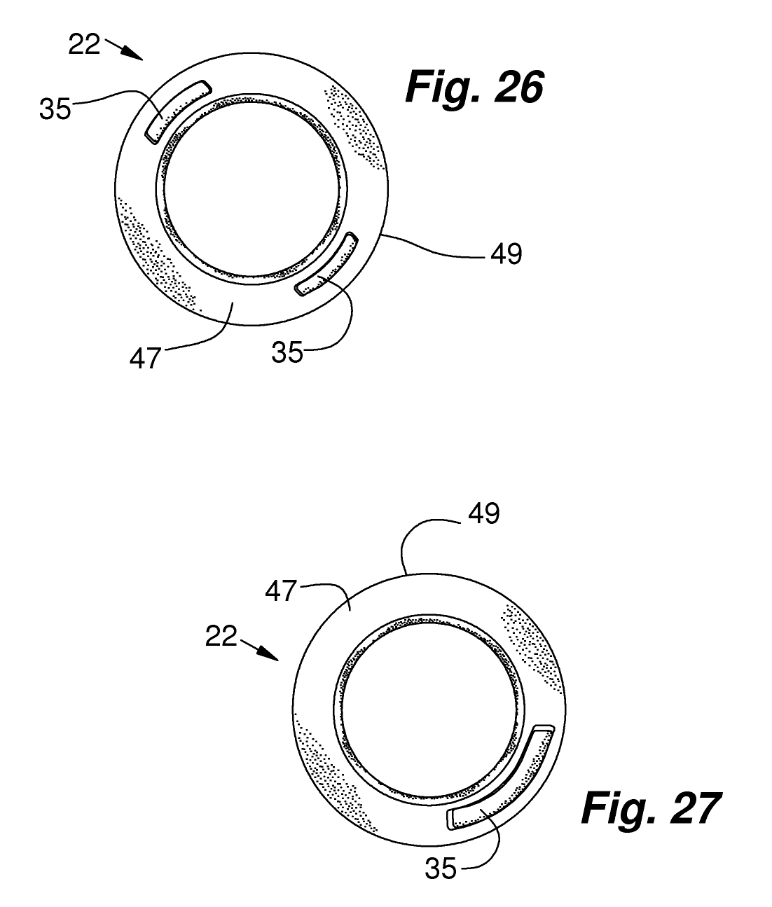

Embodiments that establish a non-rotational relationship between sleeve member 22 and distal portion 31 include, for example, spline and groove sets (for example, FIGS. 1 and 14), or stud and socket sets (for example, FIGS. 15-27). Studs 35 in certain embodiments (for example, FIGS. 15, 21, and 25-27) project generally axially in a generally proximal direction from the generally proximally facing surface 47 of annular boss 49 into mating sockets, of which 37 (FIG. 19) is diagrammatically illustratative. In further embodiments (for example, FIGS. 22-24) sockets 37 in annular boss 49 are adapted to mate with studs (not shown) that project generally axially from shoulder portion 29 in a generally distal direction.

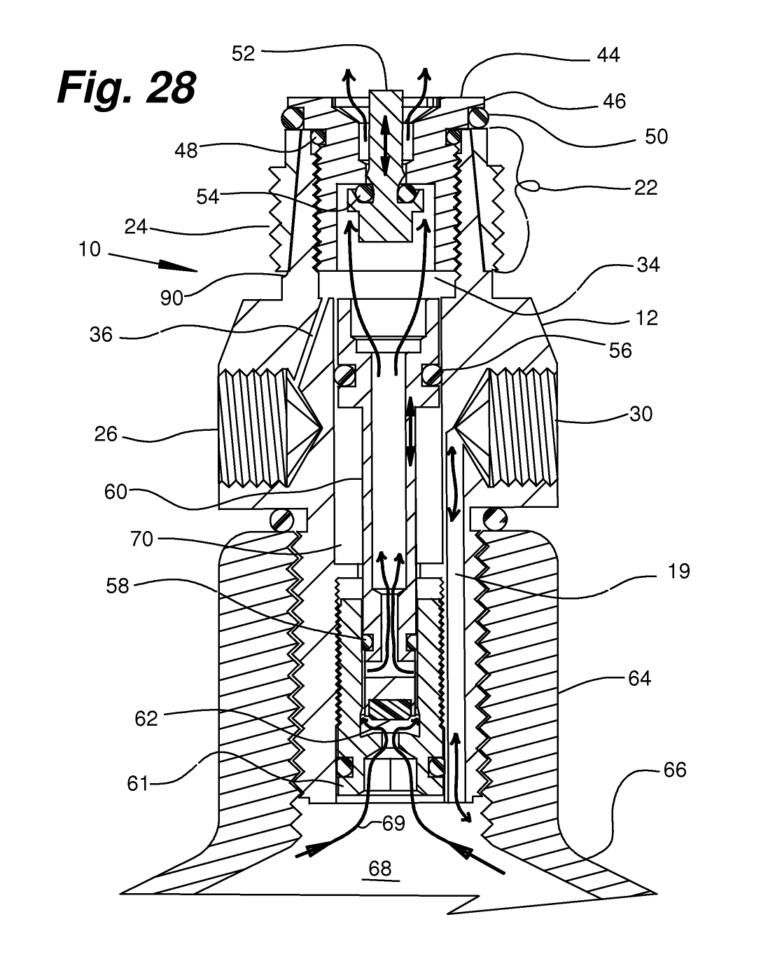

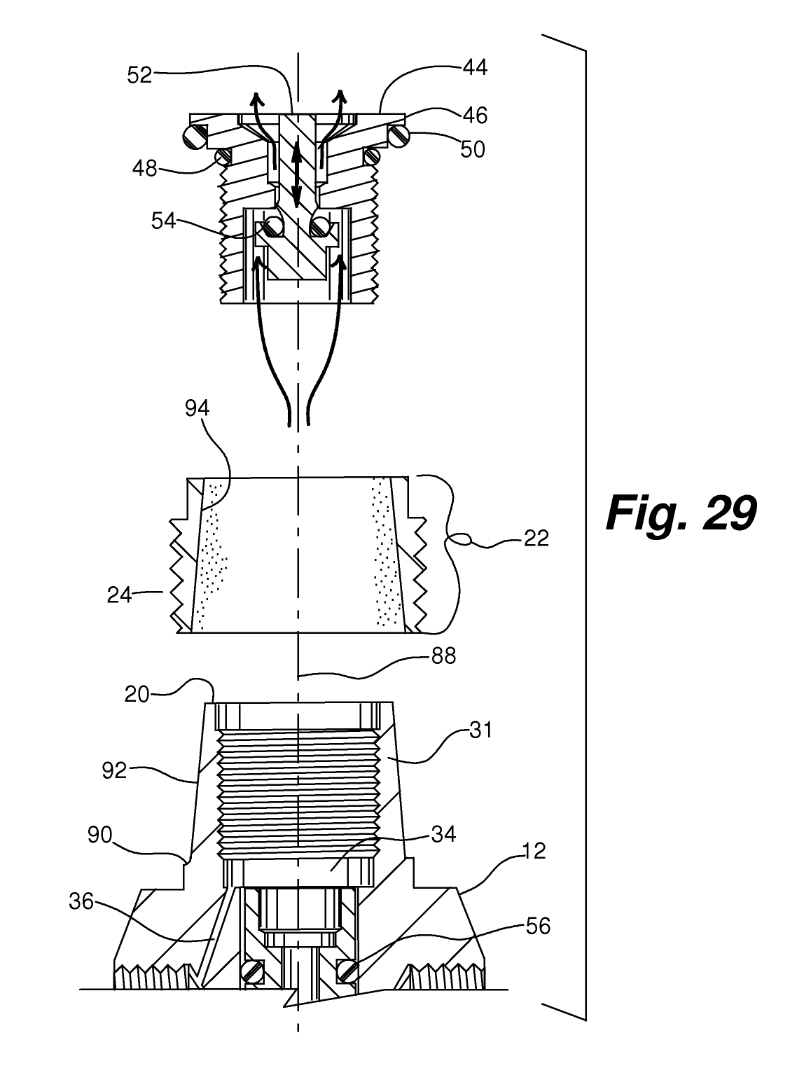

Turning to FIGS. 28 and 29, still further embodiments that establish non-rotational relationship between sleeve member 22 and distal portion 31 include, for example, a sleeve member 22 and a distal portion 31 with inner engagement surface 94 and outer engagement surface 92, respectively. Inner engagement surface 94 and outer engagement surface 92 are each axially tapered and adapted to form a frictional engagement which prevents rotation between sleeve member 22 and distal portion 31. Pry groove 90 can be used to overcome any residual axial frictional engagement between inner engagement surface 94 and outer engagement surface 92, thereby allowing sleeve member 22 to be removed from distal portion 31. This embodiment provides the further advantage of allowing sleeve member 22 to be non-rotationally engaged in an infinite number of rotational positions with respect to regulator body 11. The taper angle may vary from one embodiment to the next, with greater taper angles generally resulting in a more self-releasing engagement between sleeve member 22 and distal portion 31, thereby avoiding the need for a pry groove 90. Further, in some embodiments, inner engagement surface 94 and outer engagement surface 92 may each be tapered along only a portion of their axial length. This partial tapering allows, for example, a greater taper angle without increasing the respective sizes of sleeve member 22 and distal portion 31.

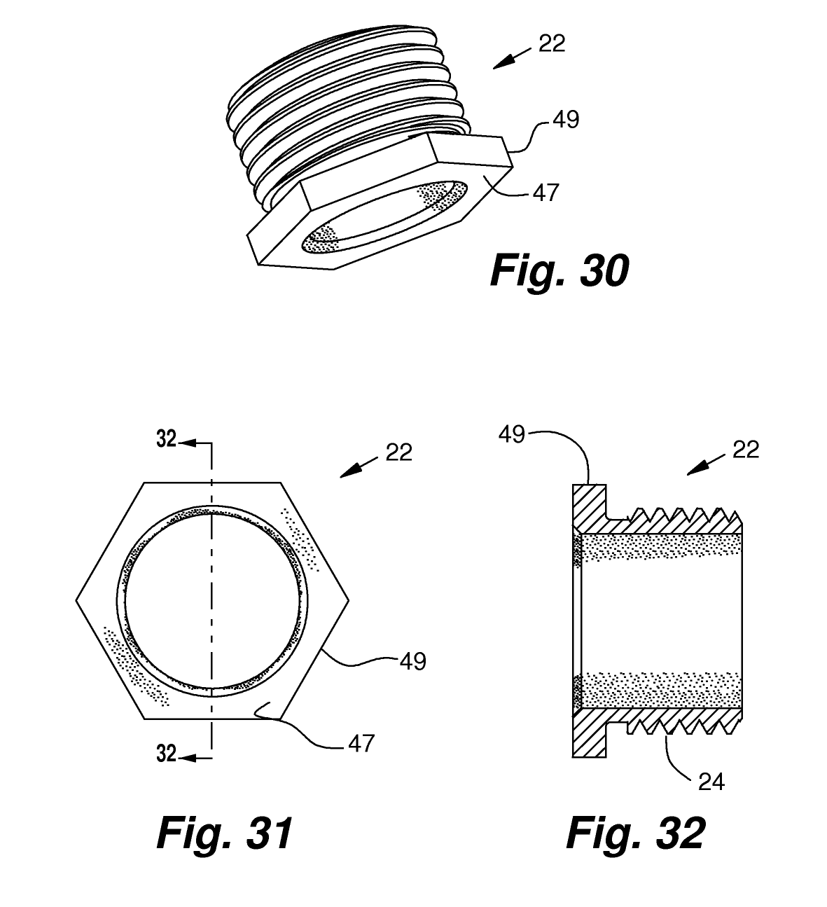

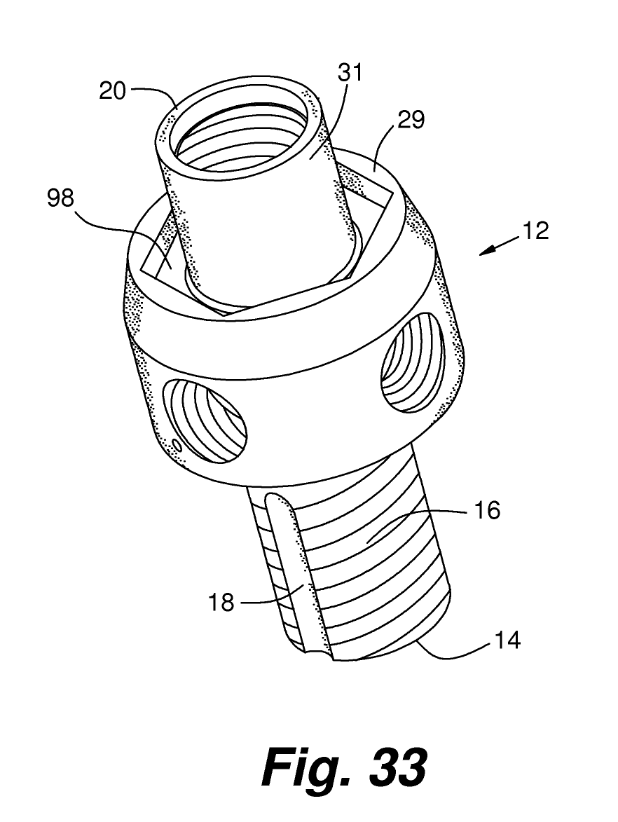

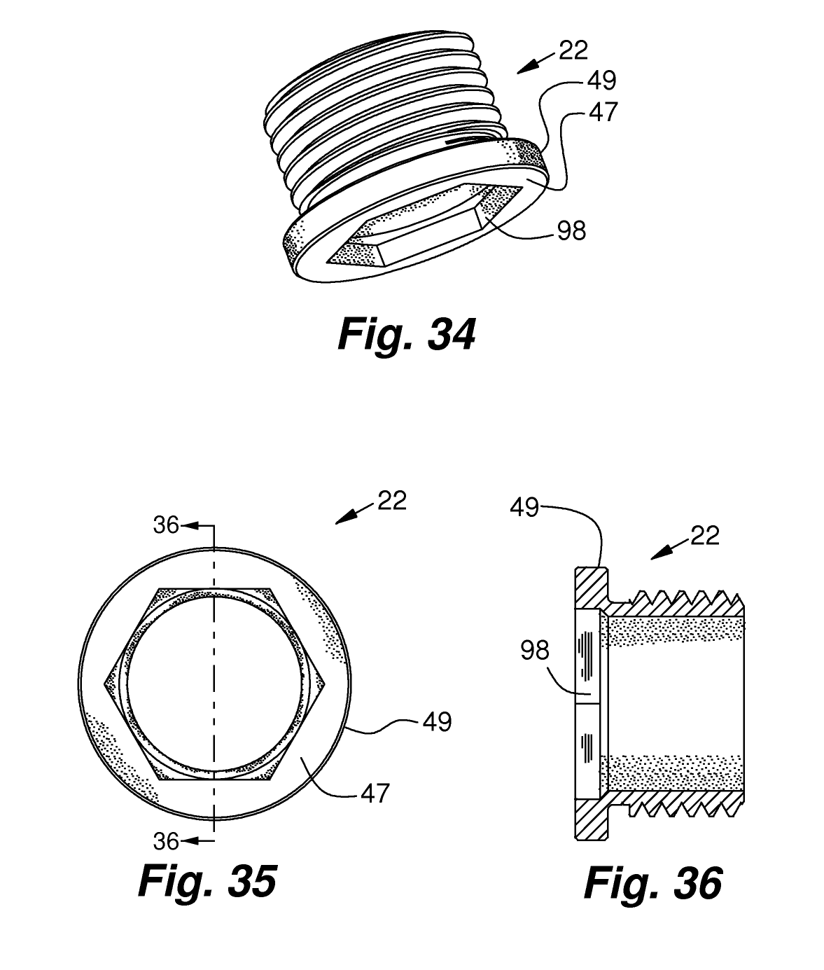

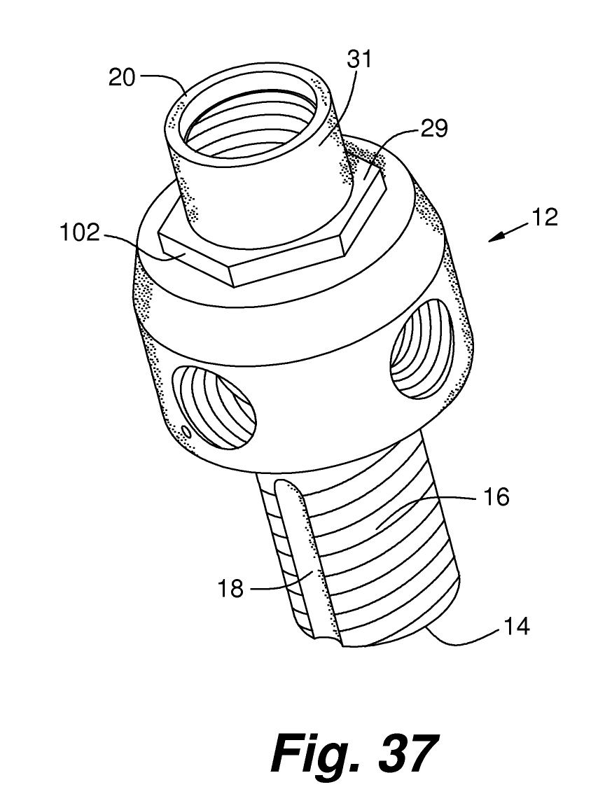

FIGS. 30-32 illustrate, for example, an embodiment of sleeve member 22 in which annular boss 49 has a polygonal periphery. This polygonal periphery is adapted to engage polygonal socket 98 in shoulder portion 29 (shown, for example, in FIG. 33), thereby preventing rotation of sleeve member 22 with respect to body portion 12. Conversely, FIGS. 34-36 illustrate an embodiment of sleeve member 22 which includes a polygonal socket 98. Polygonal socket 98 is adapted to engage polygonal periphery portion 102 in shoulder portion 29 of the embodiment of body portion 12 illustrated in FIG. 37.

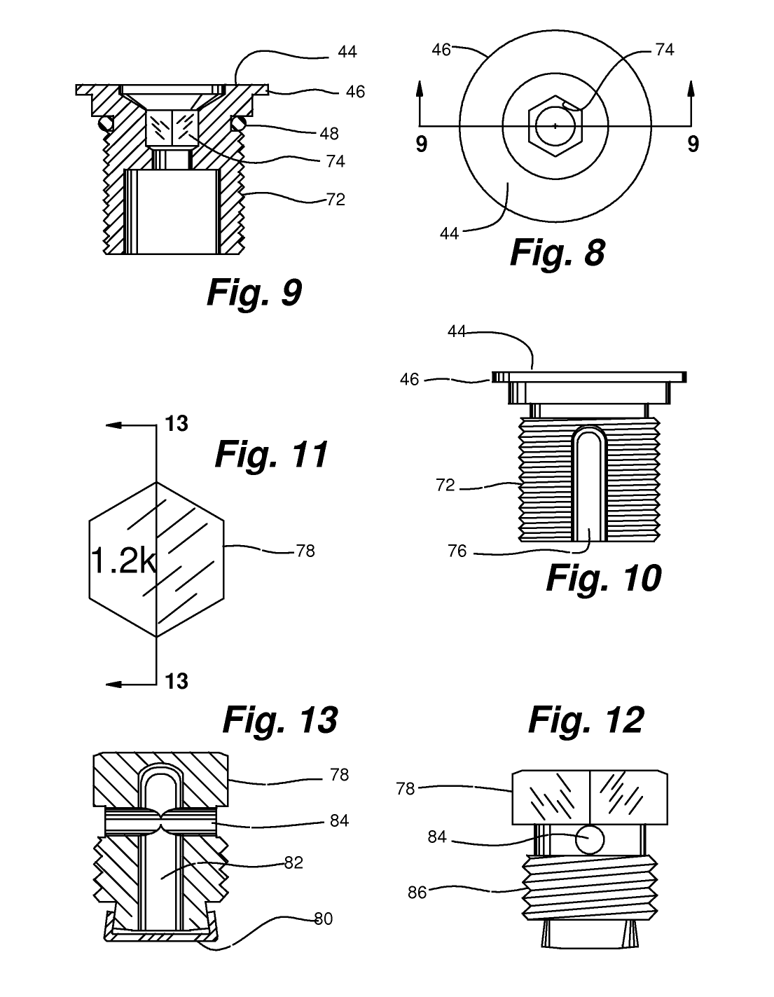

In the embodiment depicted in FIGS. 3, 4, 7 and 14, distal portion 31 includes an internal thread that is adapted to threadably engage an external thread 72 on discharge side seal member 44. Such threaded engagement is conveniently accomplished, for example, by way of rotating discharge side seal member 44 with a tool inserted into hex socket 74 (see, for example, FIGS. 8 and 9).

Flange element 46 extends radially over the distal end of sleeve member 22, but does not extend far enough to interfere with the threadable engagement of sleeve member 22 with an associated appliance or other device. Threadably tightening discharge side seal member 44 into distal portion 31 brings flange element 46 into engagement, through outer flange seal element 50, with the distal end of sleeve member 22 (see, for example, FIGS. 7 and 14). Outer flange seal element 50 may be, for example, an elastomeric seal such as a conventional O-ring. This engagement prevents sleeve member 22 from sliding axially of distal portion 31 and aids somewhat the sealing of pressure chamber 34. Inner flange seal element 48 sealingly engages the inner generally cylindrical surface of distal portion 31 to prevent gas from escaping pressure chamber 34 through the threads by which discharge side seal member 44 is mounted to distal portion 31.

In some embodiments discharge side seal member 44 may be provided with a bleed groove 76 extending through the external threads 72 to vent pressure chamber 34 in the event discharge side seal member 44 is inadvertently unscrewed while there is a discrete charge of pressurized gas held in pressure chamber 34 (see, for example, FIG. 10). Pressure chamber 34 will be fully vented before discharge side seal member 44 can be completely un-screwed from regulator body 11. Also, the venting through bleed groove 76 will alert the user to the fact that there is pressure in the regulator.

Body portion 12 extends between distal portion 31 and the proximal portion that bears male thread 16. Body portion 12 includes several ports and channels that contribute to the safe operation of the regulator 10.

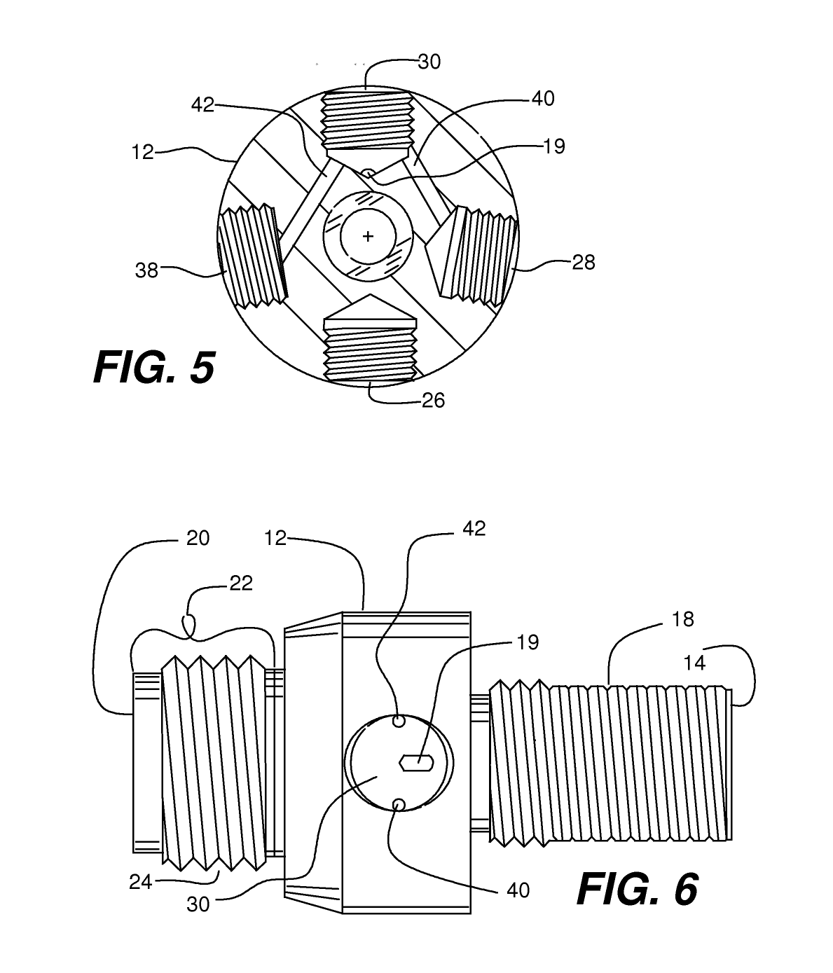

In some embodiments, body portion 12 includes a fill port 30 through which an associated tank is charged with gas (see, for example, FIGS. 1 and 4-7). Incoming gas flows from fill port 30 through fill channel 19 and into an associated tank (see, for example, FIG. 7). As indicated by the double-headed arrows in fill channel 19 in FIG. 7, gas may flow in both directions in fill channel 19. Fill channel 19 may be used to vent an associated tank. Fill port 30 is also open through first pressure channel 40 to high side pressure gauge port 28, and through second pressure channel 42 to high side pressure relief port 38 (see, for example, FIGS. 5 and 6). Because of this network of channels, fill port 30, high side pressure gauge port 28, and high side pressure relief port 38 all see approximately the same pressure as exists within the associated tank.

In the embodiment chosen for illustration, a fourth port is provided in the body portion 12 of the regulator. Low side pressure relief port 26 is directly connected to pressure chamber 34 by low pressure relief channel 36, so low side pressure relief port 26 sees the pressure that exists in pressure chamber 34. At least initially according to some embodiments, the pressure in an associated tank will exceed the pressure in the pressure chamber 34 by a substantial factor of 2 or 3 times or more. Typically, the pressure in the pressure chamber 34 will never exceed that in the associated tank. For convenience, the pressure in the tank is referred to as the high side, and that in the pressure chamber 34 as the low side. Low side pressure relief port 26 is adapted to mount therein a pressure relief member such as that shown, for example, in FIGS. 11-13. Pressure relief member 78 is threadably mounted through male thread 86 in low pressure relief port 26, and includes a rupture disk 80 that is continually exposed to the pressure in pressure chamber 34 by way of low pressure relief channel 36. Rupture disk 80 has a safe pressure rating, above which it will fracture and allow pressurized gas to flow into vent channel 82, and out to the ambient atmosphere through relief port 84. For the sake of safety, a second pressure relief member is provided in some embodiments to protect regulator 10 from any over-pressurization that may occur in pressure chamber 34. Such a second relief member may take the form, for example, of selecting the dimensions and tolerances of first piston seal 58, the adjacent piston member diameter, and the cylindrical bore that first piston seal 58 engages so that first piston seal 58 will extrude and relieve the pressure in pressure chamber 34 when that pressure exceeds a predetermined level of pressure. In certain embodiments the rupture disk 80 and first piston seal 58 are both actuated to a pressure-relieving configuration by approximately the same predetermined level of pressure. Thus, if one pressure relief member fails to actuate, the other will. Safety is thus enhanced.

Some embodiments of the regulator may accept input pressures up to, for example, approximately 5,000 psi, or higher, and can be configured to regulate an output pressure range of, for example, between approximately 1 to 5,000 psi. Embodiments are sometimes configured to have a nominal outlet pressure of, for example, approximately 700-950 psi. In some embodiments, for example, the pressure in pressure chamber 34 is vented by a pressure relief member if the pressure exceeds approximately 1.5 times the intended maximum pressure. Other pressure limits from approximately 1.2 to 2 or more times the intended maximum pressure in pressure chamber 34 will actuate one or more low side pressure relief members.

The cycle in which regulator 10 goes from holding configuration to discharge configuration to fill configuration and back to holding configuration may occur as frequently as approximately 20 to 40 times per second, or more. The frequency of this cycle is generally determined by the requirements of the application with which regulator 10 is associated.

The foregoing detailed description of the invention is intended to be illustrative and is not intended to limit the scope of the invention. Changes and modifications are possible with respect to the embodiments detailed in the foregoing description, and it is understood that the invention may be practiced otherwise than that specifically described herein and still be within the scope of the appended claims.

1. A regulator for use in a marker-regulator-tank system, said regulator being adapted to regulating the delivery of pressurized gas from a supply of said pressurized gas in said tank, said regulator comprising:
a body having a longitudinal axis, a proximal end, and a distal end, said body having a proximal portion adjacent said proximal end, a distal portion adjacent said distal end, and a body portion extending between said proximal and distal portions, said proximal portion adapted to being mounted in fluid flow communication with said tank;
a sleeve member adapted to being axially slidably received on said distal portion, said sleeve member bearing a male thread, said male thread being adapted to threadably engaging a device in said system that requires said pressurized gas for its operation; and
a discharge side seal member adapted to being retainingly engaged with said sleeve member, and mounted in said distal portion for threadable movement relative to said distal portion between restrained and released configurations with said sleeve member, when so retainingly engaged in said restrained configuration said sleeve member being adapted to being restrained from movement relative to said distal portion.

2. A regulator of claim 1 wherein said sleeve member is adapted to being received on said distal portion in a non-rotating relationship, which non-rotating relationship is adapted to being established by splines engaged in mating grooves.

3. A regulator of claim 1 wherein said sleeve member is adapted to being received on said distal portion in a non-rotating relationship, which non-rotating relationship is adapted to being established by a spline on said sleeve member engaged in a mating groove in said distal portion.

4. A regulator of claim 1 wherein said sleeve member is adapted to being received on said distal portion in a non-rotating relationship, which non-rotating relationship is adapted to being established by at least 3 splines engaged in mating grooves.

5. A regulator of claim 1 wherein said sleeve member is adapted to being received on said distal portion in a non-rotating relationship, which non-rotating relationship is adapted to being established by splines engaged in mating grooves, and said splines and mating grooves are arrayed generally symmetrically around said longitudinal axis, wherein said sleeve member can be installed so that any spline is received in any mating groove.

6-7. (canceled)

8. A regulator of claim 1 wherein said discharge side seal member includes a flange element adapted to extend generally radially outwardly to so retainingly engage said sleeve member, said flange element not extending radially outwardly far enough to interfere with said male thread's threadably engaging said device.

9. A regulator of claim 1 wherein said regulator is adapted to regulating the delivery of discrete charges of said pressurized gas.

10. A regulator of claim 1 wherein said body includes a pressure gauge port adapted to mount a pressure gauge that is adapted to indicate the level pressure of said pressurized gas in said pressure tank, and said sleeve member is adapted to being received on said distal portion in a non-rotating relationship, which non-rotating relationship is adapted to being established by splines engaged in mating grooves, said splines and mating grooves being arrayed generally symmetrically around said longitudinal axis, wherein said sleeve member is adapted to being installed so that said pressure gauge is at a convenient location for viewing by an operator.

11. A regulator adapted to regulating the delivery of discrete charges of pressurized gas from a supply of said pressurized gas, said regulator comprising:
a body having a proximal end, and a distal end, said body having a proximal portion adjacent said proximal end, a distal portion adjacent said distal end, a shoulder portion adjacent said distal portion and spaced axially from said distal end, and a body portion extending between said proximal and distal portions, said proximal portion adapted to being mounted in fluid flow communication with said supply of pressurized gas;
a discharge side seal member threadably mounted in said distal portion; and
a sleeve member axially slidably received on said distal portion, said sleeve member bearing a male thread, said male thread being adapted to threadably engaging a device in a system that requires said discrete charges of gas for its operation, said sleeve member adapted to being releasably restrained from sliding axially of said distal portion by said discharge side seal member, said sleeve member adapted to being released from such restraint by threadable axial movement of said discharge side seal member.

12. A regulator of claim 1 wherein said sleeve member is adapted to being received on said distal portion in a non-rotating relationship, which non-rotating relationship is adapted to being established by studs engaged in mating sockets.

13. A regulator of claim 1 wherein said sleeve member is adapted to being received on said distal portion in a non-rotating relationship, which non-rotating relationship is adapted to being established by at least a stud on said sleeve member engaged in a mating socket in said shoulder portion.

14. A regulator of claim 1 wherein said sleeve member is adapted to being received on said distal portion in a non-rotating relationship, which non-rotating relationship is adapted to being established by at least 3 studs engaged in mating sockets.

15. A regulator of claim 1 wherein said sleeve member is adapted to being received on said distal portion in a non-rotating relationship, which non-rotating relationship is adapted to being established by studs engaged in mating sockets, and said studs and mating sockets are arrayed generally symmetrically around said longitudinal axis, wherein said sleeve member can be installed so that any stud is received in any mating socket.

16. A regulator of claim 1 wherein said body includes a pressure gauge port adapted to mount a pressure gauge that is adapted to indicate the level of pressure of said pressurized gas in said pressure tank, and said sleeve member is adapted to being received on said distal portion in a non-rotating relationship, which non-rotating relationship is adapted to being established by studs engaged in mating sockets, said studs and mating sockets being arrayed generally symmetrically around said longitudinal axis, wherein said sleeve member is adapted to being installed so that said pressure gauge is at a convenient location for viewing by an operator.

17. A regulator of claim 1 wherein said sleeve member is generally cylindrical.

18. A regulator adapted to regulating the delivery of pressurized gas from a supply of said pressurized gas, said regulator comprising:
a body having a longitudinal axis, a proximal end, and a distal end, said body having a proximal portion adjacent said proximal end, a distal portion adjacent said distal end, and a body portion extending between said proximal and distal portions, said body portion including a pressure chamber, said proximal portion adapted to being mounted in fluid flow communication with said supply of pressurized gas; and
a sleeve member adapted to being axially slidably received on said distal portion, said sleeve member bearing a male thread, said male thread being adapted to threadably engaging a device in a system that requires said discrete charges of pressurized gas for its operation, said sleeve member adapted to being releasably restrained from sliding axially of said distal portion by a discharge side seal member that is threadably mounted in said distal portion such that said sleeve member is repeatedly re-releasable, re-rotatable and slidably re-receivable on said distal portion in a non-rotating relationship by reason of threadable movement of said discharge side seal member relative to said distal portion.

19. A regulator of claim 18 wherein said sleeve member is adapted to being received on said distal portion in a non-rotating relationship, which non-rotating relationship is established by interengagement between at least a stud and a socket.

20. A regulator of claim 18 wherein said sleeve member is adapted to being received on said distal portion in a non-rotating relationship, which non-rotating relationship is established by interengagement between at least a groove and a spline.

21. A regulator of claim 18 wherein said body includes a shoulder portion adjacent said distal portion and axially spaced from said distal end, said distal portion includes an outer engagement surface, said sleeve member includes an inner engagement surface, said outer and inner engagement surfaces are axially tapered, and said non-rotating relationship is established by frictional interengagement between said outer engagement surface and said inner engagement surface.

22. A regulator of claim 18 wherein said body includes a shoulder portion adjacent said distal portion and axially spaced from said distal end, said sleeve member includes an annular boss, said annular boss having a polygonal periphery, said shoulder portion forms a polygonal socket, and said non-rotating relationship is established by interengagement between said polygonal periphery and said polygonal socket.

23. A regulator of claim 18 wherein said body includes a shoulder portion adjacent said distal portion and axially spaced from said distal end, said sleeve member includes a polygonal socket, said shoulder portion includes a polygonal periphery portion, and said non-rotating relationship is established by interengagement between said polygonal socket and said polygonal periphery portion.

24. A regulator for use in a marker-regulator-tank system, said regulator being adapted to regulating the delivery of pressurized gas from a supply of said pressurized gas in said tank, said regulator comprising:
a body having a longitudinal axis, a proximal end, and a distal end, said body having a proximal portion adjacent said proximal end, a distal portion adjacent said distal end, a shoulder portion adjacent said distal portion, and a body portion extending between said proximal and distal portions, said body portion including a pressure chamber, said proximal portion adapted to being mounted in fluid flow communication with said tank, said distal portion including an outer engagement surface, said outer engagement surface being axially tapered; and
a sleeve member, said sleeve member bearing a male thread, said male thread being adapted to threadably engaging a device in said system that requires said pressurized gas for its operation, said sleeve member including an inner engagement surface, said inner engagement surface being axially tapered, said sleeve member adapted to being axially slidably received on said distal portion, said sleeve member adapted to being releasably restrained from sliding axially of said distal portion by a discharge side seal member that is threadably mounted in said distal portion such that said sleeve member is repeatedly re-releasable, re-rotatable and slidably re-receivable on said distal portion in a non-rotating relationship by reason of threadable movement of said discharge side seal member relative to said distal portion, said non-rotating relationship being established by frictional interengagement between said outer engagement surface and said inner engagement surface.

25. A regulator for use in a marker-regulator-tank system, said regulator being adapted to regulating the delivery of pressurized gas from a supply of said pressurized gas in said tank, said regulator comprising:
a body having a longitudinal axis, a proximal end, and a distal end, said body having a proximal portion adjacent said proximal end, a distal portion adjacent said distal end, a shoulder portion adjacent said distal portion, and a body portion extending between said proximal and distal portions, said shoulder portion forming a polygonal socket, said body portion including a pressure chamber, said proximal portion adapted to being mounted in fluid flow communication with said tank; and
a sleeve member, said sleeve member bearing a male thread, said male thread being adapted to threadably engaging a device in said system that requires said pressurized gas for its operation, said sleeve member including an annular boss, said annular boss having a polygonal periphery, said sleeve member adapted to being axially slidably received on said distal portion, said sleeve member adapted to being releasably restrained from sliding axially of said distal portion by a discharge side seal member that is threadably mounted in said distal portion such that said sleeve member is repeatedly re-releasable, re-rotatable and slidably re-receivable on said distal portion in a non-rotating relationship by reason of threadable movement of said discharge side seal member relative to said distal portion, said non-rotating relationship being established by interengagement between said polygonal periphery and said polygonal socket.

26. A regulator for use in a marker-regulator-tank system, said regulator being adapted to regulating the delivery of pressurized gas from a supply of said pressurized gas in said tank, said regulator comprising:
a body having a longitudinal axis, a proximal end, and a distal end, said body having a proximal portion adjacent said proximal end, a distal portion adjacent said distal end, a shoulder portion adjacent said distal portion, and a body portion extending between said proximal and distal portions, said shoulder portion including a polygonal periphery portion, said body portion including a pressure chamber, said proximal portion adapted to being mounted in fluid flow communication with said tank; and
a sleeve member, said sleeve member bearing a male thread, said male thread being adapted to threadably engaging a device in said system that requires said pressurized gas for its operation, said sleeve member including a polygonal socket, said sleeve member adapted to being axially slidably received on said distal portion, said sleeve member adapted to being releasably restrained from sliding axially of said distal portion by a discharge side seal member that is threadably mounted in said distal portion such that said sleeve member is repeatedly re-releasable, re-rotatable and slidably re-receivable on said distal portion in a non-rotating relationship by reason of threadable movement of said discharge side seal member relative to said distal portion, said non-rotating relationship being established by interengagement between said polygonal socket and said polygonal periphery portion.
